(19) United States
(12) Patent Application Publication
(10) Pub. No.: US 2004/0234937 A1
(43) Pub. Date: Nov. 25, 2004

(54) Terminal and menu screen display method

(76) Inventor: Hisayuki Watanabe, Iwaki-city (JP)

Correspondence Address: BRINKS HOFER GILSON & LIONE, P.O. BOX 10395, CHICAGO, IL, 60610, US

(21) Appl. No.: 10/800,153

(22) Filed: Mar. 12, 2004

(30) Foreign Application Priority Data
Mar. 17, 2003 (JP) 2003-71563
Jan. 21, 2004 (JP) 2004-13034

(51) Int. Cl. G09B 7/00

(52) U.S. Cl. 434/323

(57) ABSTRACT

A terminal controller of a vehicle-mounted terminal includes a menu-screen obtaining unit for obtaining a menu screen including link information, a connection-status checking unit for checking the connection status of a linked server specified by each piece of the link information included in the menu screen, and a display processing unit for displaying the menu screen within a display such that the connection status of each linked server checked by the connection-status checking unit can be recognized.

### BACKGROUND OF THE INVENTION

1. Field of the Invention

The present invention relates to a terminal for displaying a menu screen including link information and a method for displaying the menu screen on the terminal.

2. Description of the Related Art

With a recent widespread use of the Internet, various types of image and audio data have become easy to obtain, and users can obtain desired information with a simple operation. A user operates a terminal in his/her home or office and accesses servers through the Internet, so as to obtain desired information from the servers. For example, the contents of a HyperText Markup Language (HTML) file can be displayed in such a terminal by using browsing software called a Web browser. In the HTML file, links can be set so that a file or the like corresponding to a specific address associated with a character string can be obtained when the specific character string is selected. Therefore, when the user wants more specific information, he/she can obtain the desired information by following links included in the browser screen displayed at that time.

In this specification, a display screen of a browser screen including at least one piece of link information is called a “menu screen”, and a specific character string or the like selected for specifying a linked server is called “link information”.

An information apparatus having an automatic Web browsing function for automatically accessing each linked server included in such a menu screen has been known (for example, see Patent Document 1: International Publication No. WO98/18088 pamphlet (pp. 14 to 28 and FIGS. 1 to 16)). In this information apparatus, by sequentially and automatically following links in accordance with the rules and parameters set in advance, pieces of information which proceed like television pictures can be received while minimizing operations required for browsing Web sites on the Internet.

However, this method has the following problems. Access to the linked server corresponding to a selected piece of link information is not permitted until the piece of link information is selected from the menu screen. Therefore, the user cannot know whether he/she can access the linked server until he/she has selected a piece of link information so as to try access that linked server. Accordingly, a smooth operation cannot be achieved and favorable usability cannot be obtained. For example, due to the change of address and maintenance/inspection of the server, or when access to the Internet is performed through a wireless LAN or a mobile phone, the condition of radio waves deteriorates. Accordingly, the user may not be able to access the linked server corresponding to a piece of link information selected by him/her. In this case, the user checks a comment “inaccessible” on the display and then has to display the menu screen again so as to select another piece of link information. In this method, the user may have to perform a number of cumbersome operations in order to find an accessible server.

In the information apparatus disclosed in Patent Document 1, links are followed automatically, and thus operations required for checking the contents of a server needed by the user can be reduced. However, since the linked servers automatically change one after another, this method is inappropriate when the user wants to take the time to browse the contents of a selected server. Further, in a vehicle-mounted terminal, the communication speed is relatively low and the connection status further deteriorates depending upon the running speed of the vehicle. Therefore, the method of automatically following links is not suitable. Accordingly, it is difficult to use the information apparatus of Patent Document 1 as a vehicle-mounted terminal as is.

### SUMMARY OF THE INVENTION

The present invention has been made in view of these problems and an object of the present invention is to provide a terminal having an enhanced usability and a method for displaying a menu screen by using the terminal.

In order to solve the above-described problems, a terminal of the present invention includes a menu-screen obtaining unit for obtaining a menu screen including link information; a connection-status checking unit for checking the connection status of a linked server specified by each piece of the link information included in the menu screen; and a menu-screen display processing unit for displaying the menu screen so that the connection status of the linked server checked by the connection-status checking unit can be recognized. With this configuration, a user can recognize the connection status of the linked server corresponding to each piece of the link information included on the screen, before selecting a piece of the link information, only by viewing the menu screen. Accordingly, an inefficient operation of selecting an inaccessible server can be avoided, such that the usability can be increased.

Preferably, a process of checking the connection status by the connection-status checking unit is performed in parallel with a display process by the menu-screen display processing unit. Accordingly, the user can check the connection status while viewing the menu screen, and time otherwise spent determining The connection status can be saved. As a result, the usability can be further increased.

A discrimination mark which differs depending on a level of the connection status may be associated with the corresponding piece of the link information so that the connection status of the linked server can be recognized. Accordingly, the user can easily understand the connection status based upon the difference of the discrimination marks.

Alternatively, a color according to a level of the connection status may be applied to the corresponding piece of the link information or a portion related thereto such that the connection status of the linked server can be recognized. Accordingly, the user can recognize the connection status based upon the difference of color, and the visibility of the connection status can be further increased.

Preferably, the menu-screen display processing unit does not display a piece of the link information corresponding to an inaccessible server. Accordingly, link information corresponding to inaccessible servers is removed from a list and only effective link information can be displayed, so that an inefficient selecting operation can be prevented.

The terminal is desirably mounted upon a vehicle and the connection-status checking unit checks the connection status of the linked server while the vehicle is stopped. Accordingly, the connection status of each linked server when the vehicle is stopped, that is, when the connection status is the best, can be recognized.

The terminal is desirably mounted upon a vehicle and the connection-status checking unit checks the connection status of the linked server when the connection status changes. Accordingly, the user can know an accessible linked server when the connection status changes.

Preferably, the connection status of the linked server changes when the speed of the vehicle changes and crosses a predetermined value. In general, the connection status deteriorates when the speed of the vehicle increases. By checking the connection status in accordance with the change in the vehicle speed, an accessible linked server can be recognized when the connection status changes.

The terminal further includes a communication processing unit for receiving information transmitted from the linked server through radio waves. The connection status of the linked server changes when the electric field strength of received radio waves in the communication processing unit changes and crosses a predetermined reference value. The connection status of the linked server is directly affected by the electric field strength of received radio waves. Therefore, by checking the connection status in accordance with change in the electric field strength, an accessible linked server can be recognized when the connection status changes.

The terminal further includes a communication-medium determining unit for determining the change of the communication medium. The connection status of the linked server changes when the communication medium determined by the communication-medium determining unit changes. When the communication medium changes, for example, when the communication method or mode changes, the connection status of the linked server changes. Therefore, by checking the connection status at this time, an accessible linked server can be recognized when the connection status changes.

The terminal further includes a geographic-condition determining unit for determining geographic conditions of a driving location of the vehicle upon which the terminal is mounted. The connection status of the linked server changes when the geographic conditions determined by the geographic-condition determining unit change. The connection status of the linked server often changes when the geographic conditions of the driving location change. Therefore, by checking the connection status at this time, an accessible linked server can be recognized when the connection status changes.

The terminal further includes a road determining unit for determining the type of road on which the vehicle is running. The connection status of the linked server changes when the type of road determined by the road determining unit changes. The connection status of the linked server may change when the type of road changes. Therefore, by checking the connection status at this time, an accessible linked server can be recognized when the connection status changes.

The terminal further includes a communication-status determining unit for determining communication status and a communication-status-history storing unit for storing the history of the determined communication status. The connection status of the linked server changes when the past communication status corresponding to the driving location of the vehicle is determined to be unfavorable based upon the communication status history stored within the communication-status-history storing unit. When the past communication status is unfavorable, the current communication status also may be unfavorable for the same reason. Therefore, by checking the connection status at this time, an accessible linked server can be recognized when the connection status changes.

Preferably, the menu screen has a displayed area larger than a display, and the connection-status checking unit checks the connection status of each piece of the link information included in the entire menu screen, which can be selectively displayed within the display by scrolling or page change. Accordingly, the connection status of a linked server corresponding to each piece of the link information included in the entire menu screen can be recognized. Further, the connection status of a linked server corresponding to each piece of newly appeared link information can be recognized just after performing a scroll operation or the like, and thus usability can be further increased.

The terminal may have a function of a computer which can be connected to the Internet, and the menu-screen obtaining unit may receive the menu screen through the Internet. Accordingly, the connection status of each linked server can be recognized before selecting a piece of the link information even in a browser screen or the like in which links are set. Therefore, an inefficient operation of selecting an inaccessible server can be prevented, and thus the usability can be increased.

Information transmitted from the linked server may include music data. In this case, whether download is possible or impossible can be determined before actually selecting a song in the menu screen for which the music data is to be downloaded. Therefore, an inefficient download operation can be avoided and the operability in downloading can be increased.

The terminal may be a receiver for receiving information distributed from a broadcast station, and the menu-screen obtaining unit may retrieve the menu screen stored within a storage device incorporated in the receiver. In general, distributed information (programs) may not be received due to a bad condition of received radio waves, depending upon the setting location of the receiver. In the present invention, however, whether each program can be received or not can be recognized only by viewing the menu screen in advance. Therefore, an inefficient operation of selecting a program that cannot be received can be prevented, and thus the usability can be increased.

A method for displaying a menu screen of the present invention includes a step of displaying a menu screen including link information; a step of checking the connection status of a linked server specified by each piece of the link information included in the menu screen; and a step of reflecting the check result on the menu screen so that the checked connection status can be recognized. In this method, the user can recognize the connection status of the linked server corresponding to each piece of the link information included in the menu screen before selecting a piece of the link information only by viewing the menu screen. Therefore, an inefficient operation of selecting an inaccessible server can be avoided, and the usability can be increased.

Preferably, the step of checking the connection status of the linked server is performed when the connection status of the linked server changes. Accordingly, an accessible server can be recognized when the connection status changes.

Information transmitted from the linked server may include music data. Accordingly, whether download is possible or impossible can be determined before actually selecting a song in the menu screen for which the music data is to be downloaded. Therefore, an inefficient download operation can be avoided and the operability in downloading can be increased.

### BRIEF DESCRIPTION OF THE DRAWINGS

FIG. 1 shows a schematic configuration of a network system including a vehicle-mounted terminal of a first embodiment;

FIG. 2 shows a specific configuration of the vehicle-mounted terminal;

FIG. 3 is a flowchart showing a basic operation of displaying a menu screen in the vehicle-mounted terminal;

FIG. 4 shows a specific example of the menu screen displayed in a display;

FIG. 5 shows a specific example of the menu screen on which a connection status check result is reflected;

FIG. 6 is a flowchart showing a process of displaying the menu screen when the connection status is repeatedly checked at predetermined timing intervals in the vehicle-mounted terminal; and

FIG. 7 shows a specific configuration of a vehicle-mounted terminal of a third embodiment.

### DESCRIPTION OF THE PREFERRED EMBODIMENTS

Hereinafter, a vehicle-mounted terminal according to the embodiments of the present invention will be described with reference to the drawings.

<First Embodiment>

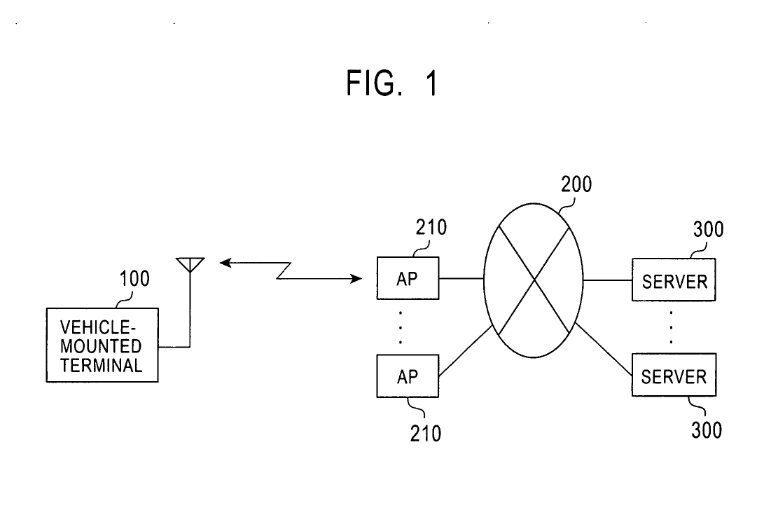

FIG. 1 shows a schematic configuration of a network system including a vehicle-mounted terminal 100 of a first embodiment. The network system shown in FIG. 1 includes the vehicle-mounted terminal 100, a network 200, and one or more servers 300 connected as necessary to the vehicle-mounted terminal 100 through the network 200.

The network 200 includes the Internet and other types of networks required for connecting the vehicle-mounted terminal 100 to each server 300. The server 300 transmits various types of information in response to access requests from the vehicle-mounted terminal 100. The number of servers 300 connected to the vehicle-mounted terminal 100 is not specified, and also the setting location and connection condition thereof are not specified. In the configuration shown in FIG. 1, the servers 300 are connected to the vehicle-mounted terminal 100, but a communication apparatus other than the servers, for example, another vehicle-mounted terminal, may be connected thereto.

The vehicle-mounted terminal 100 functions as a computer which can be connected to the Internet. More specifically, the vehicle-mounted terminal 100 has a function of performing communication by using radio waves in a wireless LAN technique as a communication medium, and is connected to the network 200 through one of access points (AP) 210 located in a predetermined communication area.

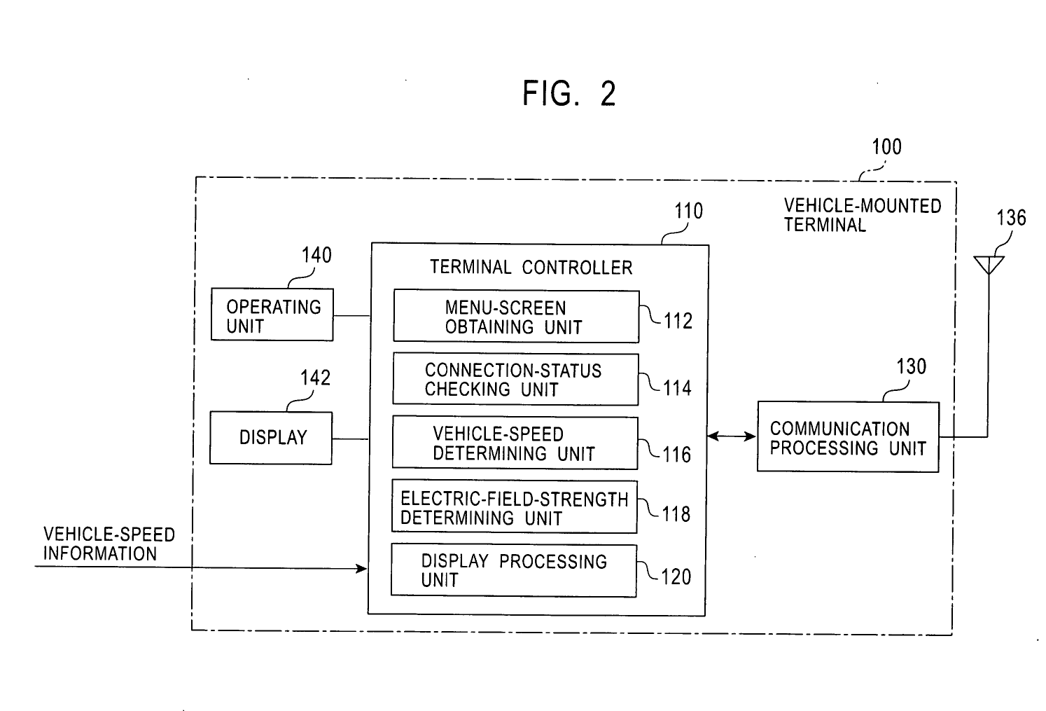

FIG. 2 shows a specific configuration of the vehicle-mounted terminal 100. As shown in FIG. 2, the vehicle-mounted terminal 100 includes a terminal controller 110, a communication processing unit 130, an operating unit 140, and a display 142.

The terminal controller 110 includes a menu-screen obtaining unit 112, a connection-status checking unit 114, a vehicle-speed determining unit 116, an electric-field-strength determining unit 118, and a display processing unit 120. The terminal controller 110 allows a processor to execute a predetermined application program stored within a memory, such as a hard disk, ROM, or RAM, so as to realize the above-described functions.

The menu-screen obtaining unit 112 obtains a menu screen including link information. There are two main types of methods for obtaining the menu screen. In one of them, the menu screen is obtained by accessing the server 300, and in the other, the menu-screen obtaining unit 112 holds the menu screen therein in advance (for example, the menu screen is generated by executing an application program).

The connection-status checking unit 114 extracts link information included in the menu screen obtained by the menu-screen obtaining unit 112 and checks the connection status of a linked server specified by each piece of the extracted link information. The connection status is checked in parallel with a menu-screen display process (as a background process). For example, an access request is transmitted to the server corresponding to each piece of the link information included in the menu screen, and the connection status (accessible or not) and communication speed are checked through an actual communicating operation.

The vehicle-speed determining unit 116 determines the speed of a vehicle upon which the vehicle-mounted terminal 100 is mounted. For example, an output signal of a vehicle-speed sensor used for a navigation apparatus or the like has been input thereto, and the vehicle speed is detected and determined based on this signal. Specifically, it is determined whether the speed is zero and the vehicle is stopped, and whether the speed has changed and crossed a predetermined value (for example, 40 km/h, which is a predetermined reference speed).

The electric-field-strength determining unit 118 determines the electric field strength of received radio waves used in radio LAN communication. For example, it is determined whether the electric field strength is (1) strong enough to maintain a favorable communication status; (2) weak and the communication status can be barely maintained; or (3) weak enough such that communication cannot be performed.

The display processing unit 120 draws the menu screen obtained by the menu-screen obtaining unit 112 and displays it within the display 142. Also, after the connection status of the linked server corresponding to each piece of the link information included in the menu screen has been checked by the connection-status checking unit 114, the display processing unit 120 draws the menu screen by reflecting the check result thereon, so that a user can recognize the connection status in the display. Specifically, a discrimination mark which differs depending upon the connection status is attached beside (for example, on the left of) a character string indicating link information, or a color according to the connection status is applied to the character string itself indicating link information or a portion related to the link information.

The communication processing unit 130 shown in FIG. 2 communicates with the access point 210 near the vehicle through an antenna 136 while complying with the standard of a wireless LAN, so that information is transmitted/received between the vehicle-mounted terminal 100 and the server 300.

The operating unit 140 is used when the user inputs instructions to the terminal controller 110. For example, a remote control unit and a touch panel are used. By using the operating unit 140, the user can select an arbitrary piece of the link information in the menu screen, scroll a hidden portion of the menu screen into view, or change pages.

The display 142 displays the menu screen drawn by the display processing unit 120.

The vehicle-mounted terminal 100 and the network system using the same of this embodiment have the above-described configuration. Hereinafter, a process of displaying a menu screen in the vehicle-mounted terminal 100 will be described.

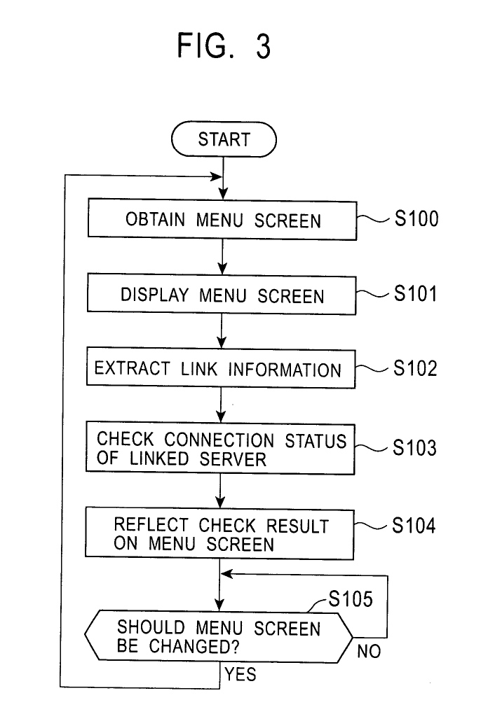

FIG. 3 is a flowchart showing a basic operation of displaying a menu screen in the vehicle-mounted terminal 100.

When a predetermined application program for displaying a menu screen is started, the menu-screen obtaining unit 112 obtains a menu screen (step S100), and then the display processing unit 120 displays the menu screen obtained by the menu-screen obtaining unit 112 in the display 142 (step S101).

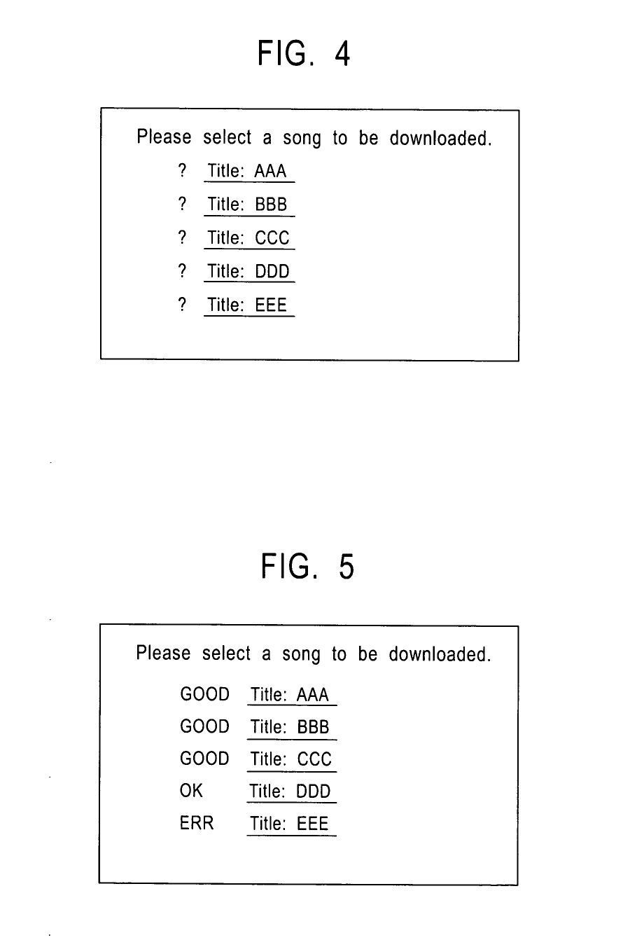

FIG. 4 shows a specific example of the menu screen displayed in the display 142. The menu screen shown in FIG. 4 is used for selecting the title of a song to be downloaded. In this screen, five titles AAA to EEE for selection are shown under a character string “Please select a song to be downloaded.” In the menu screen shown in FIG. 4, underlined character strings indicate pieces of link information. For example, when “Title: AAA” is selected from among the pieces of the link information by operating the operating unit 140, an access request to a specific address for downloading song data corresponding to the title AAA is transmitted to the network 200. This is the same for the other pieces of the link information. That is, when any piece of the link information is selected through the operating unit 140, an access request to a specific address for downloading song data of the title corresponding to the selected piece of link information is transmitted to the network 200. As shown in FIG. 4, when a plurality of pieces of link information (title AAA, title BBB, title CCC, . . . ) are included in a menu screen, the linked sever 300 or the like corresponding to each piece of the link information need not be the same, but pieces of the link information and the servers 300 are in one-to-one correspondence. Also, in the menu screen shown in FIG. 4, a ? mark indicating that the connection status has not been checked by the connection-status checking unit 114 is displayed on the left of each piece of the link information.

In parallel with the above-described process of displaying the menu screen, the connection-status checking unit 114 extracts the link information included in the menu screen (step S102) and checks the connection status of a linked server corresponding to each piece of the link information (step S103). Accordingly, the connection status, which is classified into a plurality of levels, is determined for each linked server. For example, the connection status includes three levels of “good”, “accessible”, and “inaccessible”. Herein, “accessible” means a status where the connection status can be maintained although the status is worse than “good”, and “inaccessible” means a status where access is completely impossible due to the change of the address of a server or failure of the connection.

Next, the display processing unit 120 performs processing so that the check result of the connection status obtained by the connection-status checking unit 114 is reflected on the menu screen (step S104). That is, contents of the menu screen are partly modified so that the user can recognize the connection status of a linked server corresponding to each piece of the link information.

FIG. 5 shows a specific example of the menu screen upon which the connection status check result is reflected. In the menu screen shown in FIG. 5, the ? mark attached on the left of each piece of the link information has been changed to a discrimination mark indicating the connection status of a linked server corresponding to each piece of the link information. In the example shown in FIG. 5, “GOOD” means the connection status is good, “OK” means accessible, and “ERR” (error) means inaccessible.

Next, the menu-screen obtaining unit 112 determines whether the menu screen should be changed to another (step S105). When display of another menu screen is not instructed, a negative determination is performed and step S105 is repeated. On the other hand, when a piece of the link information is selected and another menu screen is to be displayed, a positive determination is performed in step S105 and the process returns to step S100 so as to obtain a new menu screen, and then the following steps are repeated.

In this way, in the vehicle-mounted terminal 100 of this embodiment, the user can recognize the connection status of a linked server corresponding to each piece of link information included in a menu screen simply by viewing the menu screen. Since the user can recognize the connection status before selecting a piece of the link information, he/she can avoid an inefficient operation of selecting an inaccessible piece of link information. Accordingly, the usability of the terminal can be increased.

In particular, a process of checking the connection status by the connection-status checking unit 114 is performed in parallel with a process of displaying the menu screen by the display processing unit 120. Accordingly, the user can check the connection status while viewing the menu screen, and time otherwise spent determining the connection status can be saved. Therefore, the usability of the terminal can be further increased.

Further, in order to make the connection status recognizable, discrimination marks (GOOD, OK, and ERR) which differ depending upon the connection status are displayed on the menu screen. Accordingly, the user can easily recognize the connection status from these discrimination marks.

<Second Embodiment>

In the description about the vehicle-mounted terminal 100 of the first embodiment, the time for checking the connection status of a linked server corresponding to each piece of the link information in the menu screen is not referred to. However, in the vehicle-mounted terminal 100, a radio-wave state significantly changes depending upon a driving state and driving location, and the connection status changes accordingly. Therefore, the connection status should be preferably checked repeatedly at an adequate timing interval.

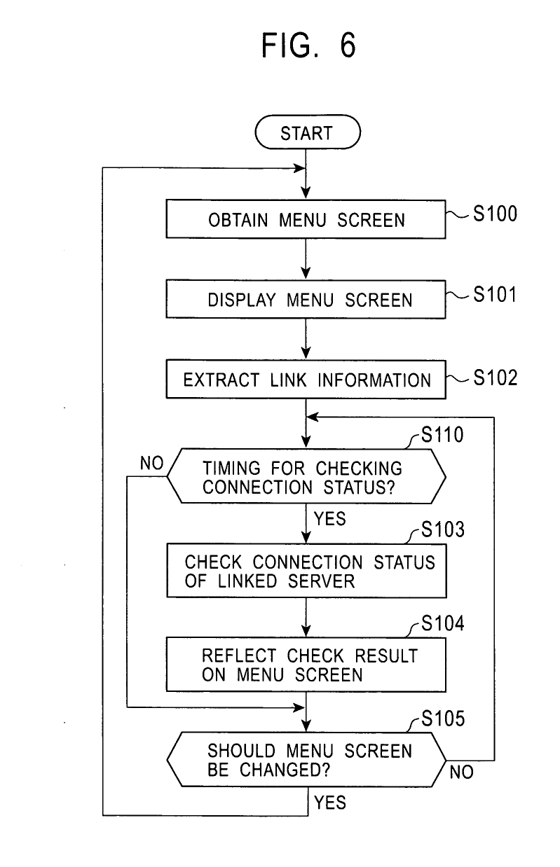

FIG. 6 is a flowchart showing a process of displaying a menu screen when the connection status is checked at a predetermined timing interval in the vehicle-mounted terminal 100. The flowchart shown in FIG. 6 is different from that shown in FIG. 3 in that step S110 is added between steps S102 and S103. Hereinafter, the different point will be described.

After the connection-status checking unit 114 has extracted the link information included in the menu screen (step S102), it determines whether the timing interval for checking the connection status has elapsed (step S110). In this embodiment, the connection status is checked in accordance with the timing interval when the connection status of a linked server changes, and the timing interval is determined by the vehicle-speed determining unit 116 and the electric-field-strength determining unit 118. The timing interval for checking the connection status includes the following cases.

(Case 1)

The connection status of a linked server is checked while the vehicle is stopped and when the speed reaches a predetermined value (for example, 40 km/h) after it starts moving. Generally, received radio waves become unstable and the radio-wave receiving state deteriorates during travel, and the connection status of the linked server deteriorates accordingly. Therefore, by checking the connection status when the vehicle is stopped and the connection status of the linked server is good, as well as when the vehicle is moving and the connection status is bad, the connection status of each linked server can be precisely recognized any time in accordance with the driving state of the vehicle. Since the vehicle repeatedly starts and stops, the time that the vehicle is not moving and the time that the speed exceeds the predetermined value alternate. Therefore, the connection status of the linked server is checked at each event. The determination whether the vehicle is stopped or not and whether the speed has exceeded the predetermined value is performed by the vehicle-speed determining unit 116.

(Case 2)

The connection status also may be checked when the speed decreases below the predetermined value, in addition to the timing events of case 1. That is, the connection status will deteriorate more significantly when the speed increases over the predetermined value (high-speed run) than when the speed decreases below the predetermined value (low-speed run). Therefore, by checking the connection status of the linked server during the two types of run, the connection status can be recognized more precisely. The determination whether the speed has decreased below the predetermined value is performed by the vehicle-speed determining unit 116.

(Case 3)

When the electric field strength of received radio waves in the communication processing unit 130 changes and crosses the predetermined reference value, that is, when the electric field strength is higher than the reference value and the received-radio-wave state is good, as well as when the electric field strength is lower than the reference value and the received-radio-wave state is not good, the connection status of the linked server is checked. Of course, the connection status is good when the radio-wave state is good, whereas the connection status is bad when the radio-wave state is bad. Therefore, by checking the connection status when the electric field strength of the received radio waves is both high and low, the connection status of each linked server can be precisely recognized any time in accordance with the electric field strength of the received radio waves.

When the electric field strength of received radio waves extremely decreases, it is clear that the connection status is “inaccessible”, and thus the connection status need not be checked. In this case, step S103 (check of connection status) can be omitted. Also, the determination whether the electric field strength of received radio waves is higher/lower than the predetermined reference value or is extremely low is performed by the electric-field strength determining unit 118.

If the time for checking the connection status has not arrived, a negative determination is performed in step S110 so as to proceed to step S105, where it is determined whether the menu screen should be changed to another. If the time for checking the connection status has arrived, a positive determination is performed in step S110 so as to proceed to step S103, where the connection status of a linked server corresponding to each piece of the link information included in the menu screen is checked. When it is determined that the menu screen need not be changed in step S105, the process returns to step S110 to determine whether the time for checking the connection status has arrived.

As described above, in the vehicle-mounted terminal 100 of this embodiment, the time for checking the connection status is determined. Therefore, the user can recognize accessible servers when the connection status changes. In particular, by checking the connection status when events causing change in the connection status occur, for example, when the vehicle speed or the electric field strength of received radio waves changes, the connection status of each linked server can be precisely recognized each time.

Further, the vehicle-mounted terminal 100 of this embodiment functions as a computer which can be connected to the Internet. Therefore, the menu-screen obtaining unit 112 can obtain a menu screen from the server 300 through the Internet. Even when a menu screen such as a browser screen in which links are set is obtained, the connection status of each linked server can be found before selecting a piece of link information. Therefore, an inefficient operation of selecting an inaccessible piece of link information can be prevented, so that the usability of the terminal can be increased.

<Third Embodiment>

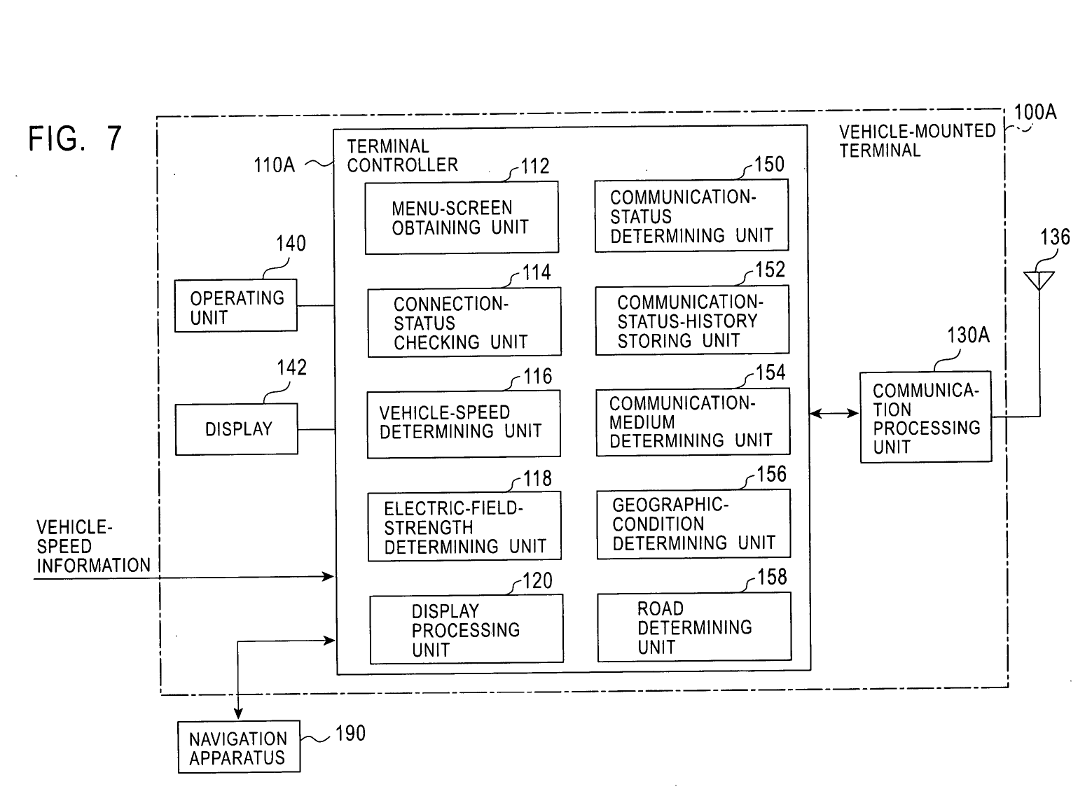

FIG. 7 shows a specific configuration of a vehicle-mounted terminal 100A according to a third embodiment. The vehicle-mounted terminal 100A includes a terminal controller 110A, a communication processing unit 130A, an operating unit 140, and a display 142. Parts basically having the same function as that in the vehicle-mounted terminal 100 shown in FIG. 2 are denoted by the same reference numerals, and the corresponding description will be omitted.

The terminal controller 110A includes a communication-status determining unit 150, a communication-status-history storing unit 152, a communication-medium determining unit 154, a geographic-condition determining unit 156, and a road determining unit 158, in addition to the units of the terminal controller 110 shown in FIG. 2.

The communication-status determining unit 150 determines a communication status when communication is actually performed. For example, it is determined whether the communication status is “good”, “unstable”, or “bad”. The communication-status-history storing unit 152 stores communication status together with additional information as a communication status history based upon a determination result of the communication-status determining unit 150, when the communication status changes. The additional information includes driving location, geographic condition, type of road, and identification information of the server 300 linked at that time, when the communication status changes.

The communication-medium determining unit 154 determines whether the communication medium has changed. The communication processing unit 130A in the vehicle-mounted terminal 100A of this embodiment can perform communication through a plurality of communication media. For example, the communication processing unit 130A has a function of selectively performing communication through a mobile phone or a wireless LAN (function of performing communication by using a plurality of methods). When the access point 210 exists near the driving location, high-speed communication is performed through a wireless LAN. On the other hand, when the access point 210 does not exist, low-speed communication is performed through a mobile phone. In such a case, the communication-medium determining unit 154 determines whether the communication medium has been changed between the wireless LAN and the mobile phone. Further, the mobile phone may be compatible with a plurality of communication modes of different communication bands. Therefore, the change of communication modes is also regarded as the change of the communication medium.

The geographic-condition determining unit 156 determines geographic conditions of a driving location. For example, the unit 156 determines whether the driving location is (1) high-rise area; (2) low-rise residential area; (3) mountainous area; or (4) other area. The road determining unit 158 determines the type of road on which the vehicle is running. For example, the road determining unit 158 determines whether the road is (1) an expressway; (2) a highway other than expressway; or (3) other type of road.

Determination by the geographic-condition determining unit 156 and the road determining unit 158 is performed based upon information transmitted from a navigation apparatus 190 connected to the vehicle-mounted terminal 100A. In this case, determination may be performed by the navigation apparatus 190 so that the geographic-condition determining unit 156 and the road determining unit 158 may receive determination results. When the navigation apparatus 190 performs route guidance (intersection guidance) along a predetermined drive route, information about the route is also transmitted to the terminal controller 110A.

The vehicle-mounted terminal 100A of this embodiment has the above-described configuration, and the operation thereof will be described below. A basic operation of the vehicle-mounted terminal 100A is the same as that of the vehicle-mounted terminal 100 of the second embodiment. Hereinafter, different points will be described. (Other timing intervals for checking the connection status)

In the second embodiment, the connection status is checked when the running status of the vehicle changes and when the electric field strength of received radio waves changes. In this embodiment, the connection status is checked at the following timing intervals (a1) to (a4) in addition to the above-described timing intervals.

(a1) The connection-status checking unit 114 checks the connection status when the communication-medium determining unit 154 determines that the communication medium has changed (“YES” in the determination of step S110 in FIG. 6).

(a2) The connection-status checking unit 114 checks the connection status when the geographic condition (high-rise area, low-rise residential area, mountainous area, or other area) determined by the geographic-condition determining unit 156 changes.

(a3) The connection-status checking unit 114 checks the connection status when the type of road (expressway, highway other than expressway, or other types of road) determined by the road determining unit 158 changes. When the vehicle temporarily runs on another road while running on a highway and when it can be expected that the vehicle will return to the highway (for example, expectation can possibly be based upon information about a driving route transmitted from the navigation apparatus 190), check of the connection status based upon change in the type of road can be omitted.

(a4) The connection-status checking unit 114 checks the connection status when the vehicle approaches a location of unfavorable (unstable or bad) communication status, which can be determined by referring to the communication status history stored in the communication-status-history storing unit 152.

(Change of Method for Displaying Connection-Status Check Result)

In addition to the example shown in FIG. 5, the check result of connection status may be displayed in the following way.

In the following case, a “GOOD” mark is displayed: when the communication speed required for transmitting/receiving contents in a linked server is lower than a currently available communication speed achieved by the communication processing unit 130A. For example, when the available communication speed is 200 kbps and when the communication speed required for receiving streaming contents from the server is 64 kbps, the “GOOD” mark is displayed accordingly.

In the following case, a “POOR” mark is displayed: when the communication speed required for transmitting/receiving contents in a linked server is a little higher than the available communication speed. For example, when the available communication speed is 200 kbps and when the communication speed required for receiving streaming contents from the server is 220 kbps (for example, less than 120% of the available communication speed), the “POOR” mark is displayed accordingly.

Also, the “POOR” mark is displayed in a case where the linked server had an unstable connection status or failure in the past, although a “GOOD” mark should be displayed according to the current condition. In this way, “POOR” mark is displayed when the linked server 300 has an unfavorable experience according to communication status history stored in the communication-status-history storing unit 152.

In the following case, an “ERR” (error) mark is displayed: when the communication speed required for transmitting/receiving contents in a linked server is higher than the available communication speed. For example, when the available communication speed is 200 kbps and when the communication speed required for receiving streaming contents from the server is 1 Mbps (for example, 120% or more of the available communication speed), the “ERR” mark is displayed accordingly.

Also, the “ERR” mark is displayed when the server 300 is busy. At this time, the connection status is clearly bad or unstable.

Also, the “ERR” mark is displayed when the network 200 is busy, and additional time is required for routing, and thus a response is delayed.

On the other hand, an “EXC” (excellent) mark is displayed when the “GOOD” mark is being displayed and when the following condition is satisfied: the processing load of the server 300 is light or the network 200 is not busy. Whether the condition is satisfied or not can be determined by monitoring the response time of the linked server 300. Also, the “EXC” mark is displayed when the electric field strength of received radio waves is favorable or when the geographic condition or the linked server 300 has a history of a good connection status. This is determined by referring to the communication status history stored in the communication-status-history storing unit 152.

As described above, in this embodiment, the connection status is checked in many cases where the connection status is likely to be changed, and thus the connection status, which changes according to driving conditions of the vehicle, can be precisely displayed on the terminal.

The present invention is not limited to the above-described embodiments, and various modifications can be realized within the scope of the present invention. For example, in each of the above-described embodiments, the connection status of each linked server is expressed by displaying a predetermined mark, such as “GOOD” or “OK”, on the left of a piece of link information included in a menu screen. Instead of using these marks, a color according to the connection status may be applied to the link information itself or a portion related to the link information. More specifically, the color of a character string indicating link information may be changed, or the character string may be underlined and the color of the underline may be changed. Accordingly, the connection status can be recognized from the difference of colors, and viewability of the connection status can be further increased.

In each of the above-described embodiments, all pieces of link information are displayed regardless of the connection status, and the “ERR” mark is attached to a piece corresponding to an inaccessible server. Alternatively, link information corresponding to an inaccessible server may be hidden. That is, in the example shown in FIG. 5, “Title: EEE” may be hidden. In this method, link information corresponding to an inaccessible server is removed from the list and only effective link information can be displayed. As a result, an inefficient selecting operation can be avoided.

The present invention can be applied when the menu screen displayed in the vehicle-mounted terminal 100 of each of the above-described embodiments has a displayed area larger than the display screen of the display 142. In that case, it is desirable that the connection-status checking unit 114 checks the connection status of link information included in the entire menu screen, which can be selectively displayed by scrolling or page change. Accordingly, the connection status of each linked server corresponding to the link information included in the entire menu screen can be recognized. Therefore, the connection status of a linked server corresponding to each piece of newly appeared link information can be recognized just after performing a scroll operation or the like, and thus operability can be further increased.

Further, the above-described vehicle-mounted terminal 100 is connected to the network 200 through the access point 210 by using a function of a wireless LAN. Alternatively, another wireless method, for example, a mobile phone, may be used in order to connect it to the network 200. Also, the present invention can be applied to another vehicle-mounted terminal other than the vehicle-mounted terminal 100 which can be connected to the server 300 through the network 200. For example, the present invention can be applied to a vehicle-mounted terminal serving as a receiver for receiving information (program data) distributed from a broadcast station. In that case, the menu-screen obtaining unit 112 retrieves a menu screen stored within a storage device incorporated in the receiver. This menu screen includes link information, which is a list of programs of available frequencies. More specifically, names of programs and names of broadcast stations are displayed as the link information. Generally, distributed information (program data) may not be received due to a bad condition of received radio waves, depending upon the setting location of the receiver. In the present invention, however, whether each program can be received or not can be recognized only by viewing the menu screen, so that an inefficient operation of selecting a program which cannot be received can be avoided. Accordingly, the operability can be increased. Incidentally, when the vehicle-mounted terminal 100 is used as a receiver, a front-end function of a receiver must be provided in the communication processing unit 130 and a function of demodulating program data must be provided in the terminal controller 110.

What is claimed is:

1. A terminal comprising:
a menu screen obtaining unit for obtaining a menu screen including link information;
a connection status checking unit for checking the connection status of a linked server specified by each piece of the link information included within the menu screen; and
a menu screen display processing unit for displaying the connection status of the linked server checked by the connection status checking unit on the menu screen.

2. A terminal according to claim 1, wherein a process of checking the connection status by the connection status checking unit is performed in parallel with a display process by the menu screen display processing unit.

3. A terminal according to claim 1, wherein a discrimination mark differs depending upon a level of the connection status and is associated with the corresponding piece of the link information.

4. A terminal according to claim 1, wherein a color according to a level of the connection status is applied to the corresponding piece of the link information or a portion related thereto.

5. A terminal according to claim 1, wherein the menu screen display processing unit does not display a piece of the link information corresponding to an inaccessible server.

6. A terminal according to claim 1, wherein the terminal is mounted upon a vehicle and the connection status checking unit checks the connection status of the linked server while the vehicle is stopped.

7. A vehicle mounted terminal comprising:
a menu screen obtaining unit for obtaining a menu screen including link information;
a connection status checking unit for checking the connection status of a linked server specified by each piece of the link information included within the menu screen when the connection status changes; and
a menu screen display processing unit for displaying the connection status of the linked server checked by the connection status checking unit on the menu screen.

8. A vehicle mounted terminal according to claim 7, wherein the connection status of the linked server changes when the speed of the vehicle changes and crosses a predetermined value.

9. A vehicle mounted terminal according to claim 7, further comprising a communication processing unit for receiving information transmitted from the linked server through radio waves,
wherein the connection status of the linked server changes when the electric field strength of received radio waves in the communication processing unit changes and crosses a predetermined reference value.

10. A vehicle mounted terminal according to claim 7, further comprising a communication medium determining unit for determining the change of the communication medium,
wherein the connection status of the linked server changes when the communication medium determined by the communication medium determining unit changes.

11. A vehicle mounted terminal according to claim 7, further comprising a geographic condition determining unit for determining geographic conditions of a driving location of the vehicle upon which the terminal is mounted,
wherein the connection status of the linked server changes when the geographic conditions determined by the geographic condition determining unit change.

12. A vehicle mounted terminal according to claim 7, further comprising a road determining unit for determining the type of road on which the vehicle is running,
wherein the connection status of the linked server changes when the type of road determined by the road determining unit changes.

13. A vehicle mounted terminal according to claim 7, further comprising a communication status determining unit for determining communication status and a communication status history storing unit for storing the history of the determined communication status,
wherein the connection status of the linked server changes when the past communication status corresponding to the driving location of the vehicle is determined to be unfavorable based upon the communication status history stored within the communication status history storing unit.

14. A vehicle mounted terminal according to claim 7, wherein the menu screen has a displayed area larger than a display, and the connection status checking unit checks the connection status of each piece of the link information included within the entire menu screen which can be selectively displayed in the display by scrolling or page change.

15. A vehicle mounted terminal according to claim 7, further comprising a function of a computer which can be connected to the Internet,
wherein the menu screen obtaining unit receives the menu screen through the Internet.

16. A vehicle mounted terminal according to claim 7, wherein information transmitted from the linked server includes music data.

17. A vehicle mounted terminal according to claim 7, further comprising a function of a receiver for receiving information distributed from a broadcast station,
wherein the menu screen obtaining unit retrieves the menu screen stored within a storage device incorporated in the receiver.

18. A method for displaying a menu screen, comprising:
displaying a menu screen including link information;
checking the connection status of a linked server specified by each piece of the link information included within the menu screen; and
reflecting on the menu screen the checked connection status.

19. A method according to claim 18, wherein checking the connection status of the linked server is performed when the connection status of the linked server changes.

20. A method according to claim 18, wherein information transmitted from the linked server includes music data.
